(19) United States
(12) Patent Application Publication
(10) Pub. No.: US 2016/0055578 A1
(43) Pub. Date: Feb. 25, 2016

(54) SYSTEM AND METHOD FOR MONITORING STUDENT LOAN DEBT RELIEF

(71) Applicant: George Janas, Winter Park, FL (US)

(72) Inventor: George Janas, Winter Park, FL (US)

(21) Appl. No.: 14/832,200

(22) Filed: Aug. 21, 2015

Related U.S. Application Data
(60) Provisional application No. 62/040,200, filed on Aug. 21, 2014.

(51) Int. Cl. G06Q 40/02

(52) U.S. Cl. CPC G06Q 40/025; G06Q 50/2053

(57) ABSTRACT

The system and method for monitoring student loan debt relief includes receiving student loan data of a borrower over a network into a database having a microprocessor and a memory that stores the student loan data. In addition, the method includes monitoring a plurality of universal resource locators (URL) over the network corresponding to a plurality of debt relief programs, respectively, to detect when a new set of rules is published on an URL for a respective debt relief program. The method also includes retrieving the new set of rules over the network from an URL of a respective debt relief program into the database that stores the new set of rules when the new set of rules is detected, and transmitting a formatted debt relief option using the new set of rules over the network to a remote computer device of the borrower.

### I. FIELD OF THE INVENTION

The present invention relates generally to the financial industry, and more specifically to a system and method for student loan debt relief.

### II. BACKGROUND

Currently, the U.S. student loan debt is estimated to have exceeded $1.3 trillion with approximately thirty types of student loans and a total of nineteen different repayment options. Unfortunately, there are an estimated seven million student loan debtors in default. Many borrowers are not aware of the options that may be available to them in order to avoid default or to recover from a default on their student loans. However, the student loan debt relief programs are complex and are difficult if not impossible to navigate successfully for most borrowers. Moreover, the student loan debt relief programs are dynamic by constantly having new requirements, rules, and thresholds. The new rules are typically only disseminated through the use of a website on the Internet that sponsors the particular student loan debt relief programs. Accordingly, a borrower may qualify for a program under new rules that the borrower previously did not qualify. Likewise, a borrower may qualify for a student debt relief program under old rules, but may not qualify under new rules. Thus, resulting in a waste of time and energy by erroneously selecting a student debt relief program for which the borrower does not qualify under the new rules. In addition, certain debt relief programs may have a limited budget in which to provide relief. Thus, once a certain amount of debt relief has been provided or a number of borrowers have enrolled, a particular program may not have any further money to provide student debt relief to any additional borrowers. Thus, having timely notice of the programs that the borrower qualifies is beneficial to expanding the options available to the borrower.

The complexity of the student loan system has put borrowers at distinct tactical and strategic disadvantages when considering repayment options. The tactical disadvantage is demonstrated in the underestimation of the intricacies of the loans and the loan attributes by the borrowers, servicers and debt relief agencies. The strategic disadvantage lies in the lack of knowledge and information to achieve and acquire an available option.

The current main driving variables include fifty-nine (59) unique, potential loan status codes that reflect the repayment history of the individual loan and ten (10) distinct loan origination date segments that are reflective of when a loan was received, which allows for the proper legislative factors to be associated with that particular loan, to determine what repayment options are available. Simple math dictates that most people that hold student loans are faced with the challenge of discerning through an overwhelming multitude of unique variable combinations that apply to their situation. On top of that, each scenario has multiple, potential repayment solutions. A statistically arduous and practically impossible task.

The strategic reality of student loans is that disinformation, misinformation and vague ambiguities have led to a looming crisis of nonpayment and outright default. The analysis must be quick, it must be easy to understand what to do with the product of the analysis and solution acquisition must be achievable in a step-by-step process.

Accordingly, there is a need for a method and system that can timely identify those student loan debt relief programs that are available to a particular borrower and to implement the appropriate options that are available. There is also a need to monitor student debt relief program requirements published on the Internet and to timely alert the borrower to changes on those program requirements.

It is, therefore, to the effective resolution of the aforementioned problems and shortcomings of the prior art that the present invention is directed.

However, in view of the prior art at the time the present invention was made, it was not obvious to those of ordinary skill in the pertinent art how the identified needs could be fulfilled.

### III. SUMMARY

The following presents a simplified summary of one or more embodiments in order to provide a basic understanding of some aspects of such embodiments. This summary is not an extensive overview of the one or more embodiments, and is intended to neither identify key or critical elements of the embodiments nor delineate the scope of such embodiments. Its sole purpose is to present some concepts of the described embodiments in a simplified form as a prelude to the more detailed description that is presented later.

A system and method for monitoring student loan debt relief is disclosed. In a particular exemplary embodiment, the method includes receiving student loan data of a borrower over a network into a database comprising a microprocessor and a memory that stores the student loan data, monitoring a plurality of universal resource locators (URL) over the network corresponding to a plurality of debt relief programs, respectively, to detect when a new set of rules is published on an URL for a respective debt relief program. The method also includes retrieving the new set of rules over the network from an URL of a respective debt relief program into the database that stores the new set of rules when the new set of rules is detected, selecting particular data from the student loan data to compare to at least one new set of rules, where a different set of rules corresponds to each different student loan debt relief program, and formatting the student loan data with the at least one new set of rules into an option, and transmitting the formatted option for debt relief over the network to a remote computer device of the borrower.

The method may also include generating a chart on the remote computer device using the formatted option to illustrate the respective student loan debt relief program within the plurality of different student loan debt relief programs, visually identifying at least one available option of a plurality of options for the student loan debt relief program on the remote computer device, and receiving a selected option by the borrower over the network from the remote computer device into the database. The method may include generating at least one implementation report for display to identify steps necessary to receive student loan debt relief pursuant to the selected option, and displaying a graphical user interface (“GUI”) on the remote computer device to apply for the selected option. In addition, the method may include using the student loan data to format a sequence of forms of the new set of rules required to transmit to the respective URL for approval of the selected option for student loan debt relief.

In a particular exemplary embodiment, the method includes displaying a visual indicator on the GUI as to a status of completion for implementation of the selected option for student loan debt relief. The method may include determining whether the selected option for student loan debt relief is approved by a loan provider by receiving an alert over the network from the respective URL, and implementing the selected option for student loan debt relief.

In a particular exemplary embodiment, the method includes submitting student loan data into a remote database over a network using a graphical user interface (“GUI”) of a computer device of a borrower, the remote database comprising a microprocessor and a memory that stores the student loan data. The method also includes receiving a formatted option with the student loan data with at least one new set of rules using the computer device, viewing a chart displayed by the GUI of a plurality of available options of student loan debt relief using the student loan data, receiving additional formatted options from the remote database as a result of monitoring a plurality of universal resource locators (URL) over the network corresponding to a plurality of debt relief programs, respectively, to detect when a new set of rules is published on an URL for a respective debt relief program. The method also includes selecting at least one option for the student loan debt relief program using the GUI, and receiving over the network from the remote database an implementation report having steps necessary displayed on the GUI to receive student loan debt relief pursuant to the selected at least one option.

In a particular exemplary embodiment, the method includes monitoring a plurality of universal resource locators (URL) over a network corresponding to a plurality of debt relief programs, respectively, to detect when a new set of rules is published on an URL for a respective debt relief program, the database having a microprocessor and a memory that stores the student loan data, and retrieving the new set of rules over the network from an URL of a respective debt relief program into the database that stores the new set of rules when the new set of rules is detected.

To the accomplishment of the foregoing and related ends, one or more embodiments comprise the features hereinafter fully described. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### IV. BRIEF DESCRIPTION OF THE DRAWINGS

FIG. 1 is a flow diagram of a method of student loan debt relief;

FIG. 2 is a continuation of the flow diagram of the method illustrated in FIG. 1;

FIG. 3 is a screen shot of the graphical user interface (“GUI”) displaying a student loan debt worksheet;

FIG. 4 is a screen shot of the GUI displaying income and expenses for an exemplary borrower;

FIG. 5 is a screen shot of the GUI displaying a financial budget and employment summary for the exemplary borrower;

FIG. 6 is a screen shot of the GUI displaying a sample question from a student loan questionnaire;

FIG. 7 is a screen shot of the GUI displaying a summary of sample questions from the student loan questionnaire;

FIG. 8 is a screen shot of the GUI displaying additional sample questions from the summary;

FIG. 9 is a screen shot of the GUI displaying additional sample questions from the summary;

FIG. 10 is a screen shot of the GUI displaying student loan programs and options that may be available to the borrower;

FIG. 11 is a screen shot of the GUI displaying additional student loan programs and options;

FIG. 12 is a screen shot of the GUI displaying a particular requirement for an option for an exemplary student loan debt relief program that was selected;

FIG. 13 is a screen shot of the GUI displaying individual debt worksheets for consolidation;

FIG. 14 is a screen shot of the GUI displaying consolidation repayment options;

FIG. 15 is a screen shot of the GUI for entering personal data of a borrower;

FIG. 16 is a screen shot of the GUI displaying a sequence of steps to implement a selected option for a student loan debt relief program;

FIG. 17 is a screen shot of the GUI displaying a quantitative summary of borrowers active within the student loan debt relief system;

FIG. 18 is a screen shot of the GUI displaying an exemplary form to be executed by the borrower and stored electronically;

FIG. 19 is a screen shot of the GUI displaying a payment screen;

FIG. 20 is a screen shot of the GUI displaying a borrower portal that the borrower accesses to begin processing towards implementation of a particular student loan debt relief program;

FIG. 21 is a screen shot of the GUI displaying a status of the borrower;

FIG. 22 is a screen shot of the GUI displaying instructions for the borrower portal; and

FIG. 23 is a screen shot of the GUI regarding accessing National Student Loan Data System.

### V. DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

The invention includes addressing in an efficient and effective manner both the tactical and strategic disadvantages that borrowers face. Not only does the system rapidly identify the precise loan situation, it quickly ascertains which of the potential repayment solutions is applicable by disseminating the necessary variables in a survey-like fashion to account for macro-factors such as vocation, hardship, residency, income and family size, for example, and situational micro-factors related to the events surrounding the procurement of the student loans in question. The generation of the output of this comprehensive analysis results in an easily understood, easy to follow action plan that outlines the steps necessary to implement available solutions.

In a particular exemplary embodiment, student loan data is stored in the National Student Loan Data System (“NSLDS”). A student may access his or her own student loan data by accessing the NSLDS website at www.nslds.ed.gov using a personal identification number (“PIN”). The PIN can only be used by the student and cannot be given to anyone else in order to access the student loan data stored by the NSLDS. Accordingly, the student can access the NSLDS website using the PIN and the NSLDS will create a text file that can be uploaded to a database 102 of the system used in the method described below.

The method and system uses rules and key data selected from the student loan data by a Student Loan Option Decision Engine to generate a matrix of every option that is available for debt relief so that the student knows all his or her options that are available. The matrix may be identified as the Student Loan Option Tree. For example, the matrix may indicate that the student qualifies for a disability benefit but if the student is denied for any reason, the other options are also displayed in the matrix so that the student can proceed to be accepted for the next available option. Another example is where a student may have multiple options to resolve the loans. Some of the loans of the student may qualify for no relief, but other loans may qualify for forgiveness and/or consolidation. All these options are readily displayed to the student in the matrix. In addition, the method and system can identify the consequences of a particular option. For example, the consequences of choosing forgiveness of a loan over rehabilitation and the impact on the credit rating of the student.

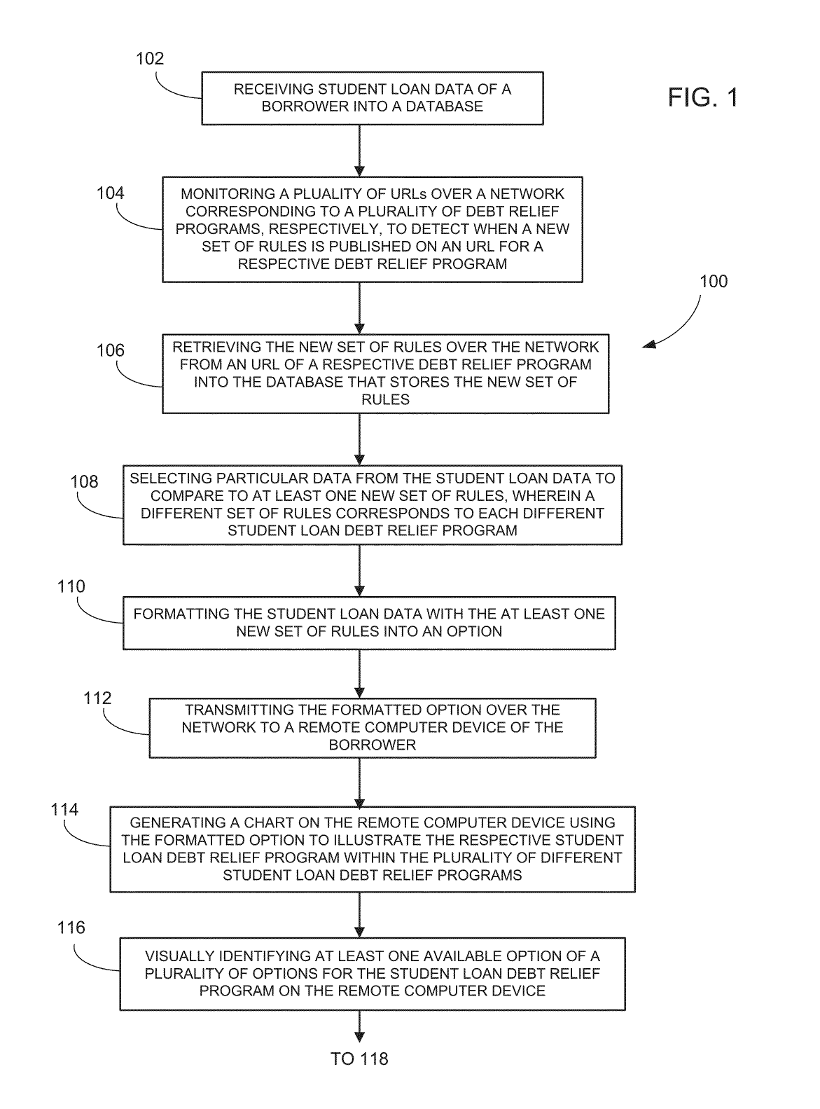

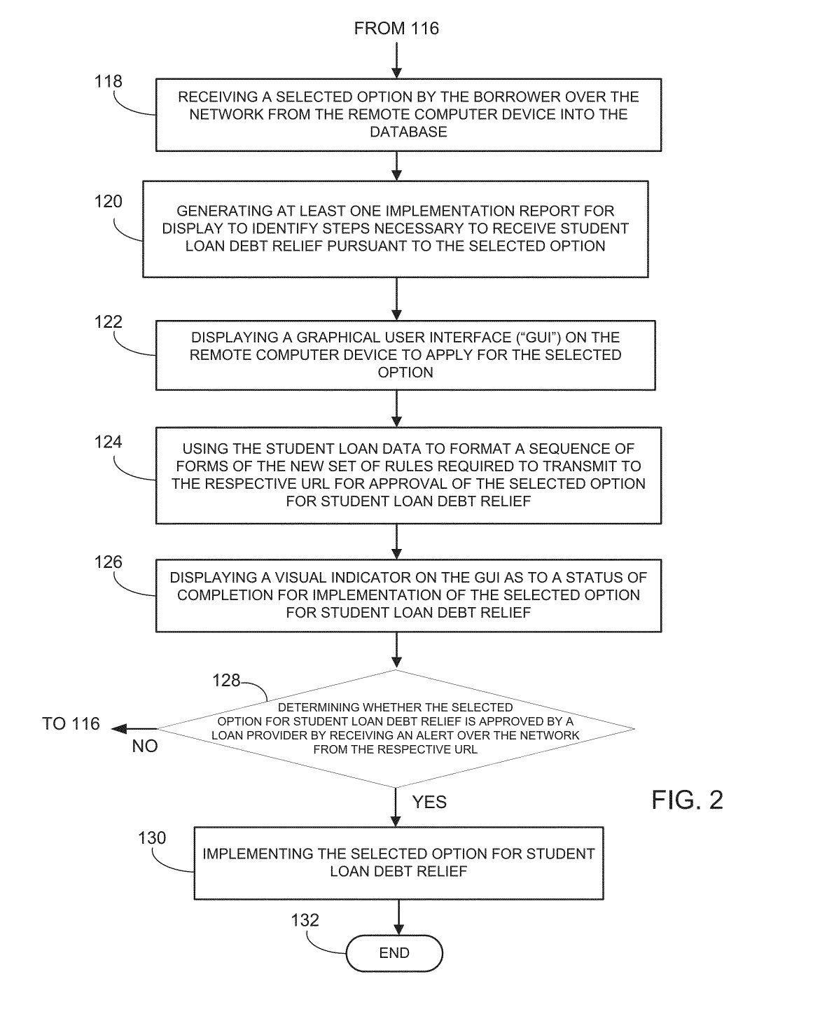

Referring to FIGS. 1-2, the student loan data of a borrower is received by the database, at 102. Moving to 104, the method includes monitoring a plurality of universal resource locators (URL) over the network corresponding to a plurality of debt relief programs, respectively, to detect when a new set of rules is published on an URL for a respective debt relief program.

The new set of rules are retrieved, at 106, over the network from an URL of a respective debt relief program into the database that stores the new set of rules when the new set of rules is detected. The monitoring and retrievable features may be intended to be continuous, but may be subject to inadvertent interruptions due to an interruption in power supply or connection to the network, for example, that may present a temporary break in the monitoring and/or retrievable before the connection can be re-established. Alternatively, the monitoring may be according to a schedule such as every day, every twelve hours, every hour, or every minute, for example.

It is critical that the monitoring be such that any change in the new rules or new debt relief programs that are available are retrieved and communicated timely to the borrower (as described below) so that the borrower does not miss an opportunity to participate in a particular debt relief program due to failing to timely have knowledge of such program. Preferably the communication is to the borrower's smart phone, for example, which is typically with the borrower at all times.

Moving to 108, particular data is selected from the student loan data to compare to at least one set of rules, where a different set of rules corresponds to each different debt relief program. At least one debt relief program may be (automatically) selected when the particular data meets the corresponding set of rules. Often times, several debt relief programs are available to the borrower.

The student loan data is formatted, at 110, with the at least one new set of rules into an option. The formatted option may be transmitted over the network to a remote computer device of the borrower, at 112.

A chart may be automatically generated to illustrate the selected debt relief program(s) within a plurality of different debt relief programs, at 114. For example, the chart will display nine debt relief programs that are potentially available to the borrower, and the chart will distinguish which debt relief program(s) that the borrower qualifies and which ones the borrower does not qualify based on the requirements of the respective debt relief program. At 116, at least one available option of a plurality of options for the selected debt relief program is identified. Each debt relief program has multiple options that may be available such as cancellation, forgiveness, default intervention, repayment, postponement, offer in compromise, bankruptcy, or any combination thereof. Accordingly, the borrower can easily determine which debt relief programs are available, and which options are available to the borrower under each of the available debt relief programs that the borrower meets the requirements.

A selected option, at 118, is received by the borrower over the network from the remote computer device into the database. The borrower may select the option(s) that the borrower wants to evaluate. Subsequently, an implementation report is generated for display, at 120, to identify steps necessary for the borrower to receive debt relief pursuant to the selected option. Moving to 122, a graphical user interface (“GUI”) is displayed to the borrower in order for the borrower to apply for the selected option. A sequence of forms are prepared, at 124, that are required for approval of the selected option for debt relief. A visual indicator, at 126, is displayed on the GUI as to a status of completion for implementation of the selected option for debt relief. If the selected option for debt relief is approved by the loan provider, at 128, then the borrower must comply with the terms of the selected option for debt relief, at 130, until the terms are completed, at 132. If the selected option for debt relief is not approved, at 128, then the borrower must select a different available option of the selected debt relief program, at 116, and a different implementation report is generated, at 120.

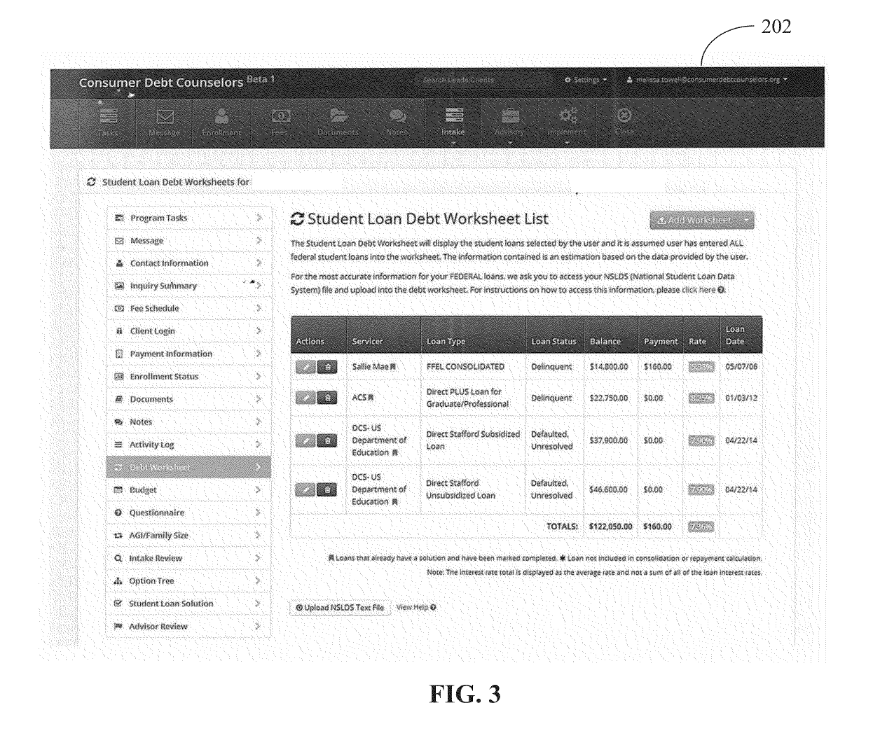

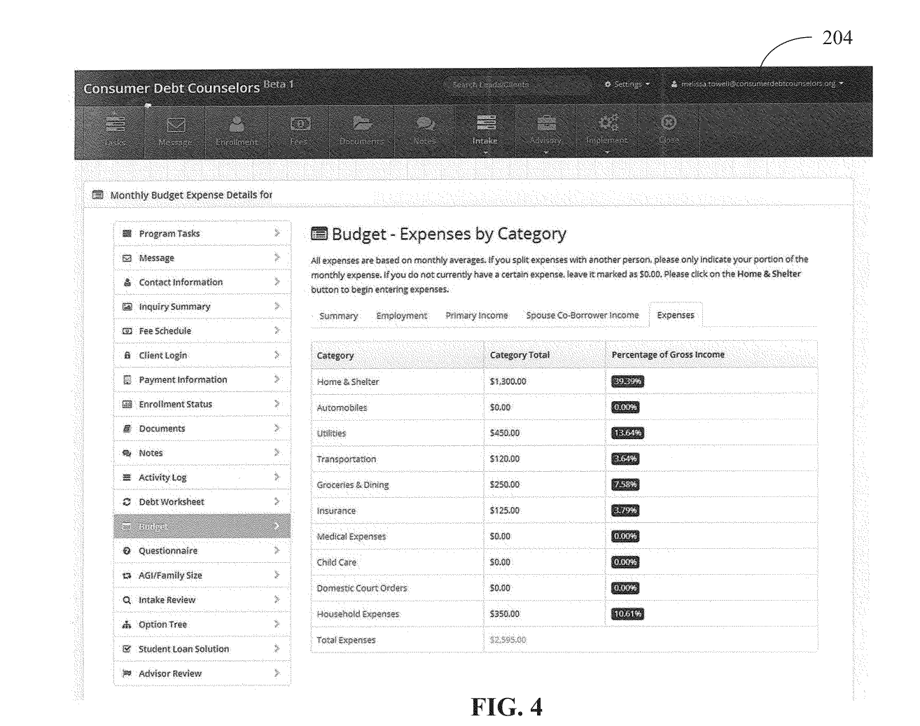

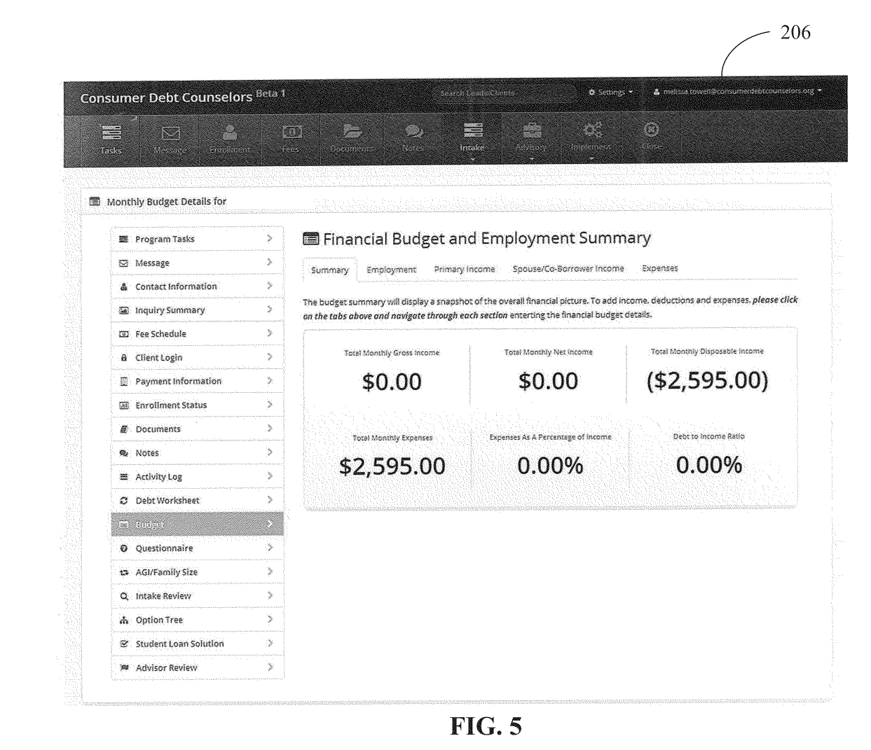

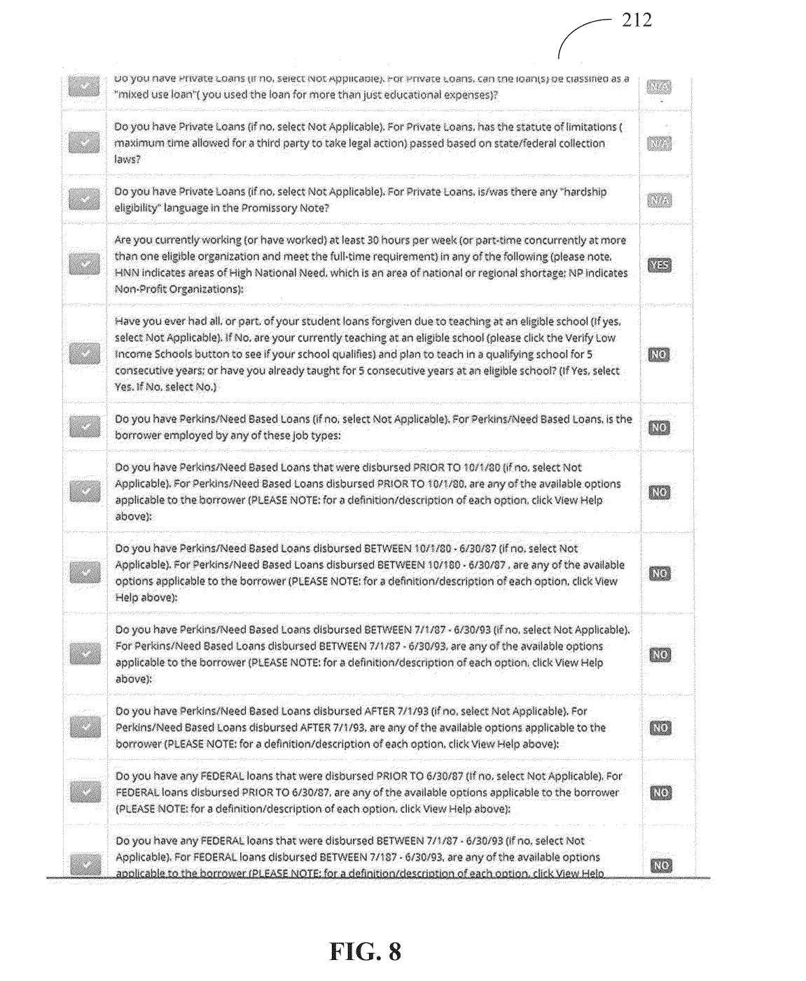

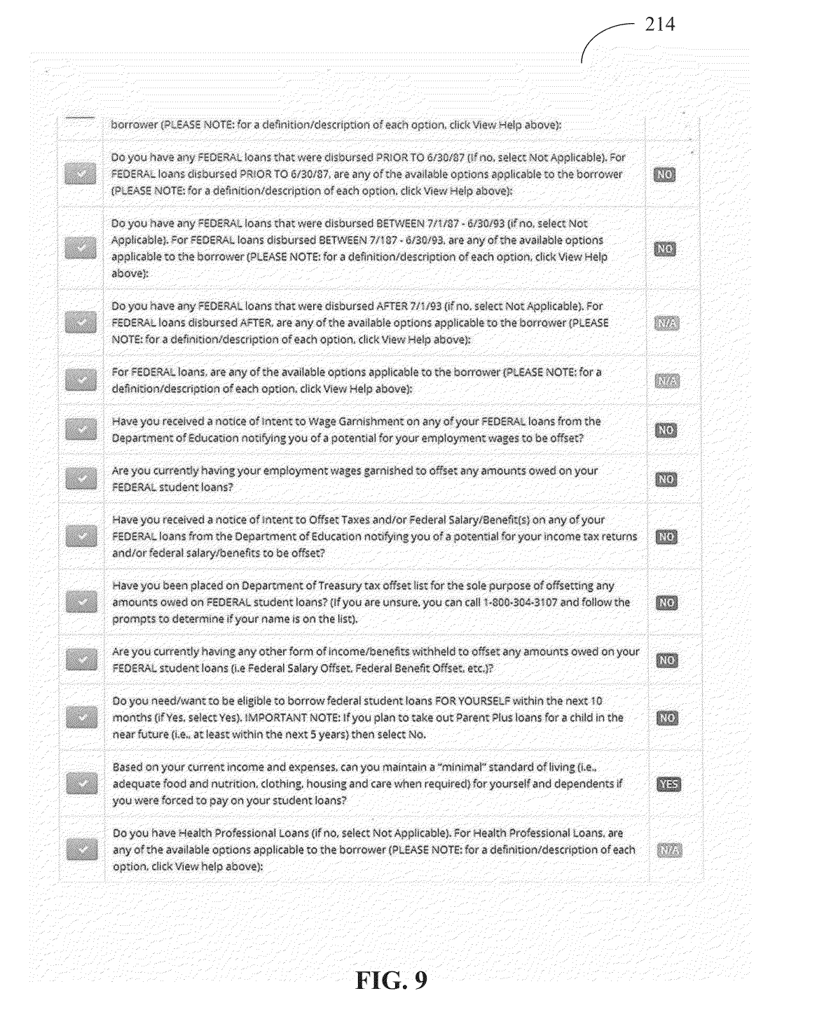

Referring now to FIGS. 3-9, screen shots from the GUI are shown. FIG. 3 is a screen shot 202 of the GUI showing a Debt Worksheet. The Debt Worksheet displays the student loans selected by the borrower (or “user”) and all federal student loans that have been entered into the worksheet. The information displayed in the Debt Worksheet is an estimation based on the data provided by the borrower. The Debt Worksheet includes the servicer, loan type, loan status, balance, payment, rate, and loan date. The borrower can select the Budget tab to display the Budget on the GUI. For example, FIG. 4 is a screen shot 204 showing expenses by category. The categories of expenses include, home & shelter, automobiles, utilities, transportation, groceries & dining, insurance, medical expenses, child care, domestic court orders, and household expenses, for example. Each category has a monetary total and percentage assigned of gross income. The Budget includes a summary, employment, primary income and spouse income. FIG. 5 is a screen shot 206 of a summary of the Financial Budget and Employment Income, which includes total monthly gross income, total monthly net income, total monthly disposable income, total monthly expenses, expenses as a percentage of income, and debt to income ratio.

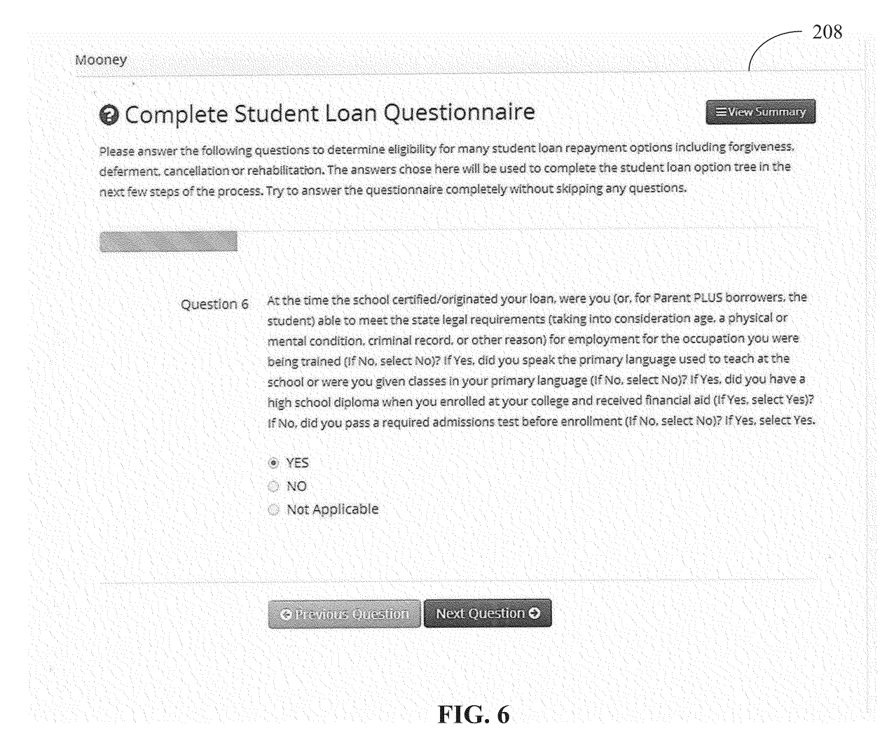

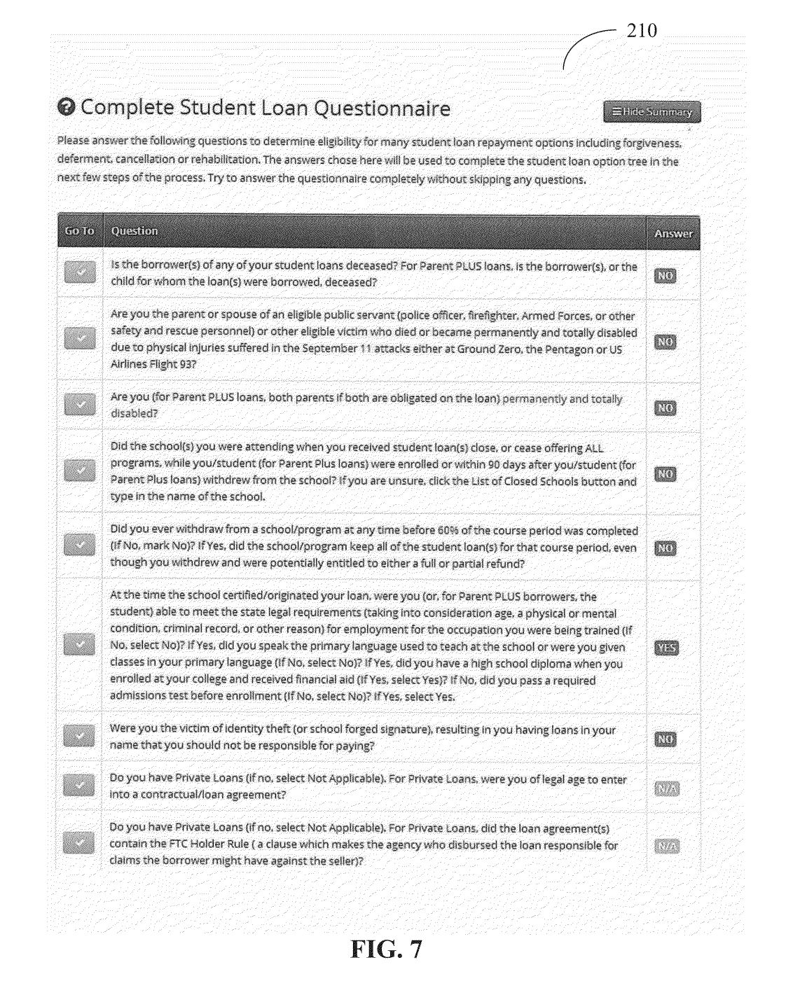

To determine a borrower's eligibility for student loan repayment options including, forgiveness, deferment, cancellation or rehabilitation, the borrower completes a Student Loan Questionnaire. FIG. 6 is a screen shot of an exemplary question used in the process to generate a student loan option tree discussed below. FIGS. 7-9 are screen shots 210, 212, 214 of a summary of the questions and answers of the Student Loan Questionnaire.

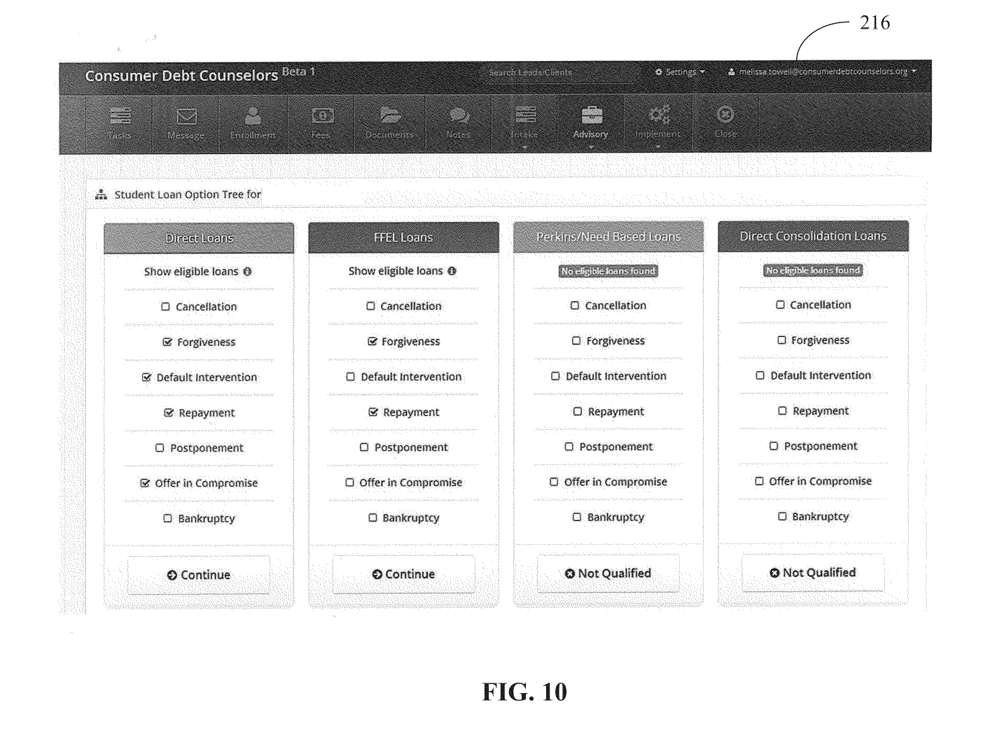

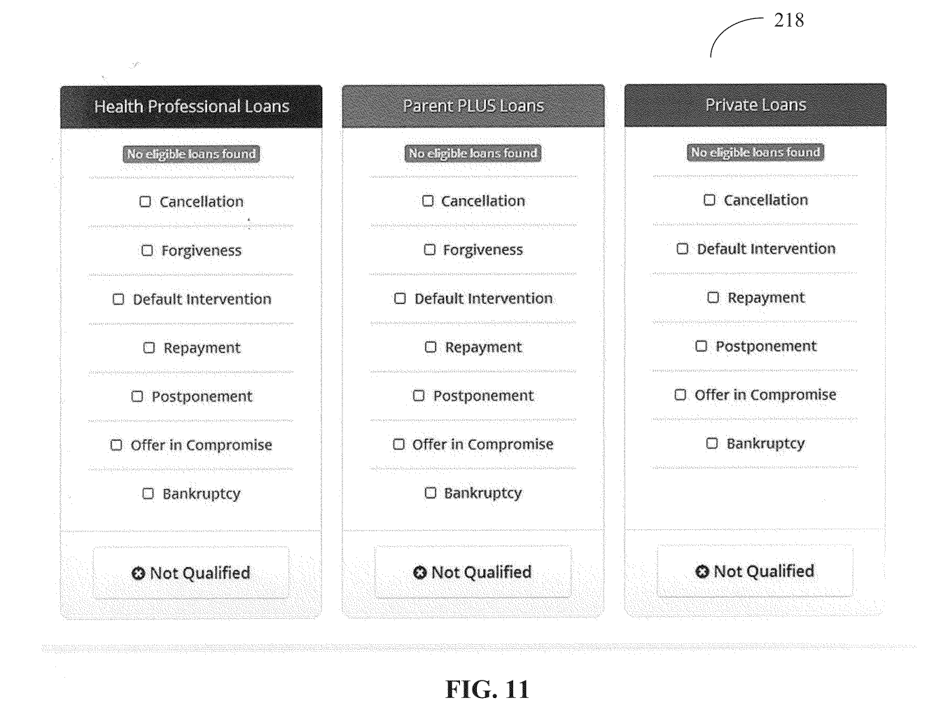

Using the results of student loan data including the Student Loan Questionnaire, and Debt Worksheet, a Student Loan Option Tree is automatically generated. Screen shots 216, 218 of the Student Loan Option Tree is illustrated in FIGS. 10 and 11. In order to generate the Student Loan Option Tree, particular data from the student loan data (e.g., Debt Worksheet, Student Loan Questionnaire, et al.) is selected and compared to a set of rules for each possible debt relief program. When the set of rules for each possible debt relief program are met or satisfied, then those debt relief programs are automatically selected and identified to the borrower. In one particular illustrative embodiment, all the available debt relief programs are displayed in a chart, which is the Student Loan Option Tree, and those that the borrower does not qualify are marked as “Not Qualified.” The Student Loan Option Tree includes the type of loan and each available option. The available options are marked with a check mark as illustrated in FIG. 10. Referring to FIG. 10, the Direct Loans and FEEL Loans are visually identified as having available options. The remaining loans, such as Perkins/Need Based Loans, Direct Consolidation Loans, Health Professional Loans, Parent PLUS Loans, and Private Loans, are marked as “Not Qualified.” Accordingly, those loans have no options available to the borrower. However, the Direct Loans have options of forgiveness, default intervention, repayment, and offer in compromise. The FEEL Loans have options of forgiveness and repayment.

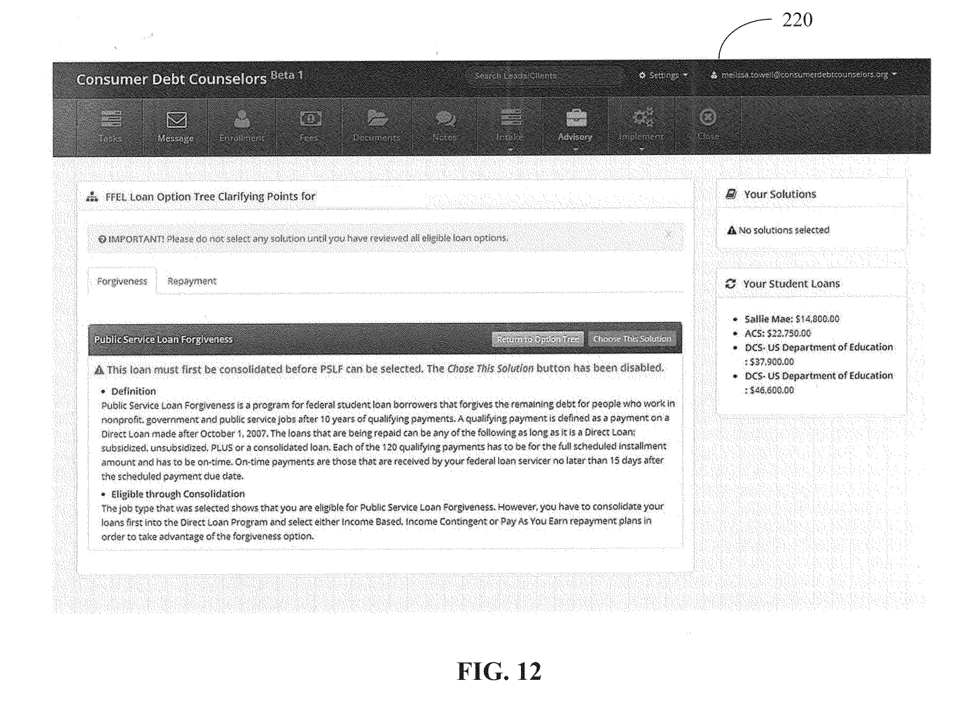

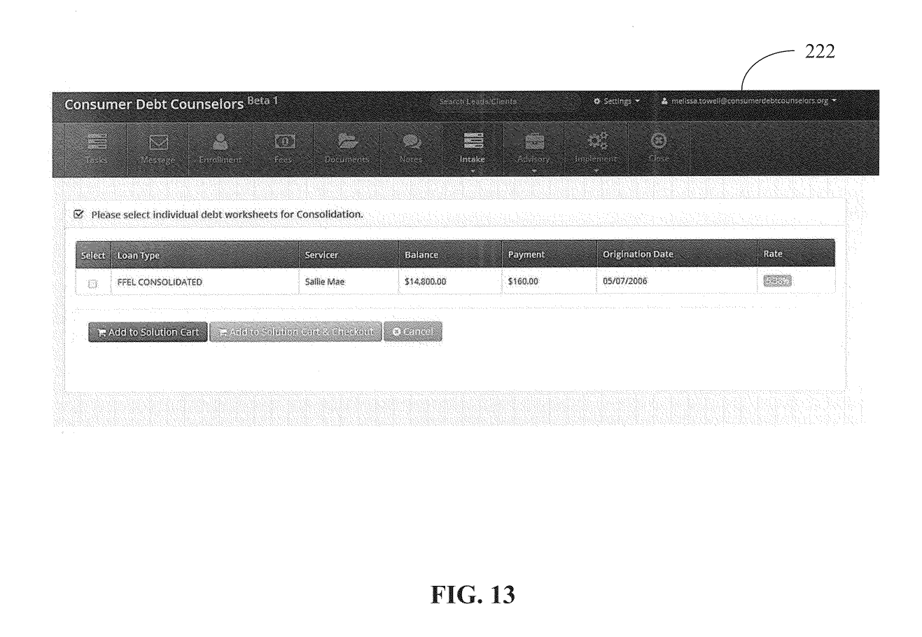

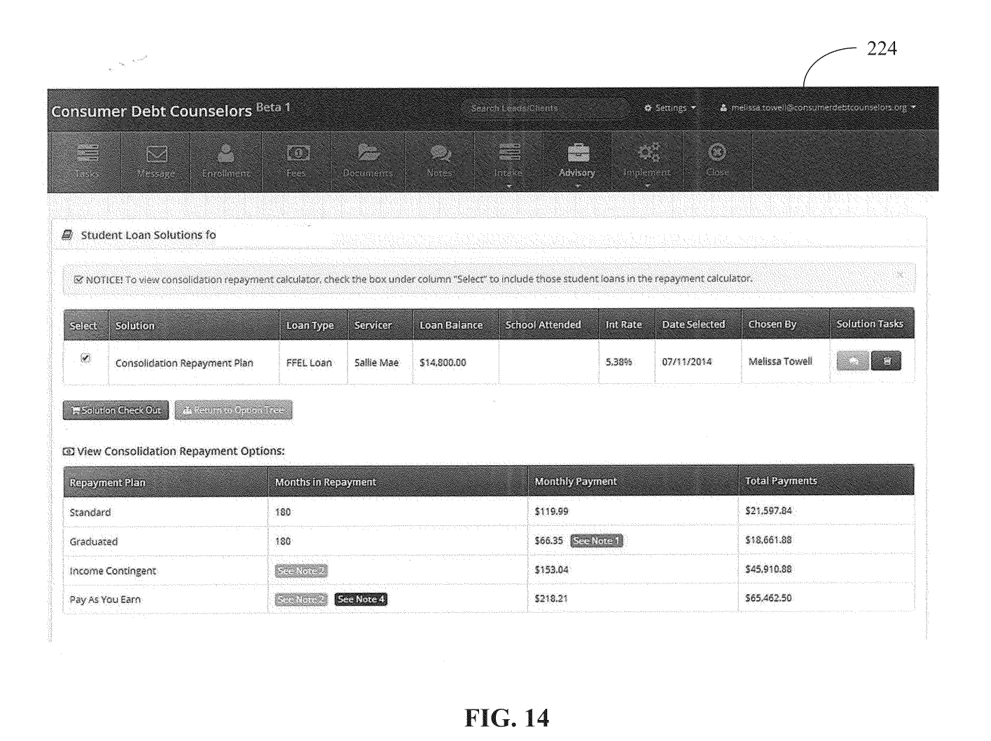

Continuing to FIG. 12 and screenshot 220, the two options of forgiveness and repayment are displayed under two tabs. In particular, under the forgiveness tab, a warning is displayed along with a description of a definition of forgiveness and eligibility through consolidation is provided. In FIG. 13, screenshot 222 of the GUI shows that the individual debt worksheet for consolidation has been selected, which is the FEEL loan. The servicer, balance, payment and origination date is displayed. Referring now to FIG. 14, the consolidation repayment options are displayed in screenshot 224. This includes the different options for the repayment plan such as standard, graduated, income contingent, and pay as you earn. For each repayment plan, the number of months in repayment, monthly payment and total payments is calculated and displayed using the GUI.

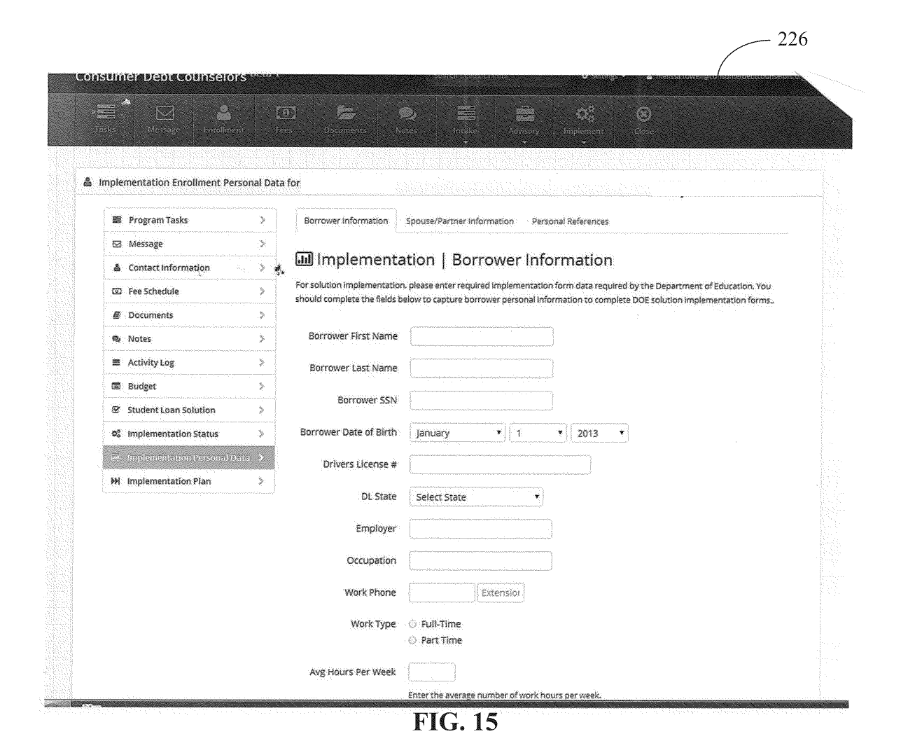

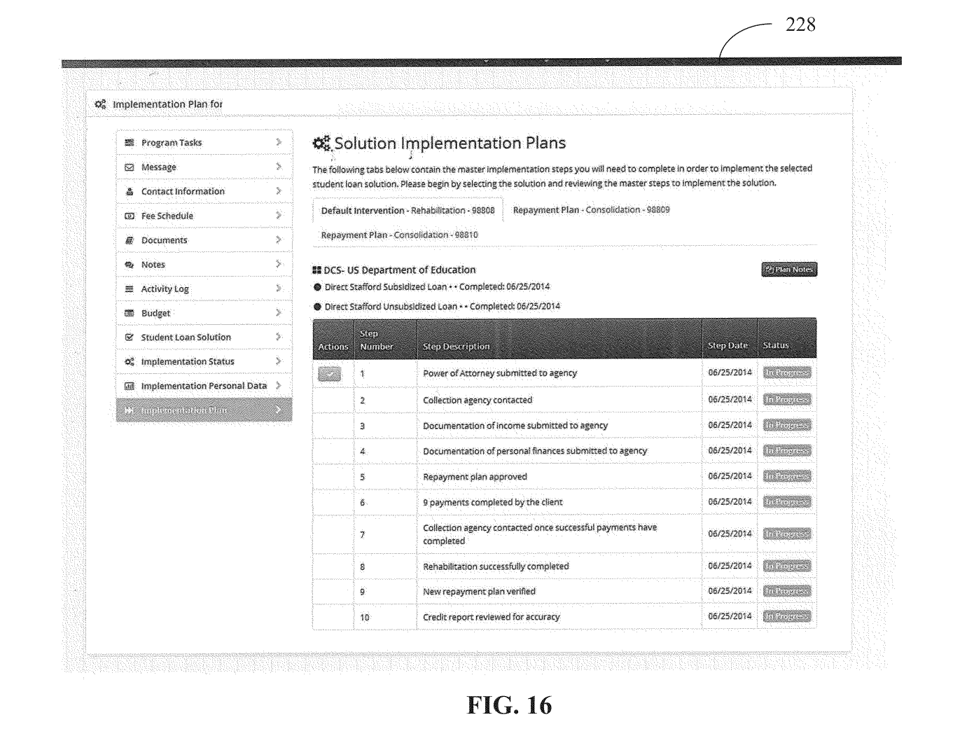

The above is an exemplary scenario of the Student Loan Option Tree and options that are generated and displayed by the method and system for student loan debt relief. Continuing with this particular exemplary scenario, the next step is the implementation of the selected option. Referring now to FIGS. 15-17, a screen shot 226 of the GUI is displayed for the borrower to provide additional information required by the Department of Education. Screen shot 228 of the GUI shown in FIG. 16 shows tabs that include the master implementation steps the borrower needs to complete in order to implement the selected student loan solution (or option) such as rehabilitation or consolidation, for example. The borrower begins by selecting the solution and reviewing the master steps to implement the solution. The master steps may include power of attorney, contacting collection agency, submitting documentation of income to agency, submitting documentation of personal finances to agency, approval of repayment plan, payments completed by borrower, contacting collection agency once successful payments have been completed, successfully completing rehabilitation, verifying new payment plan, and reviewing credit report for agency, or any combination thereof, for example.

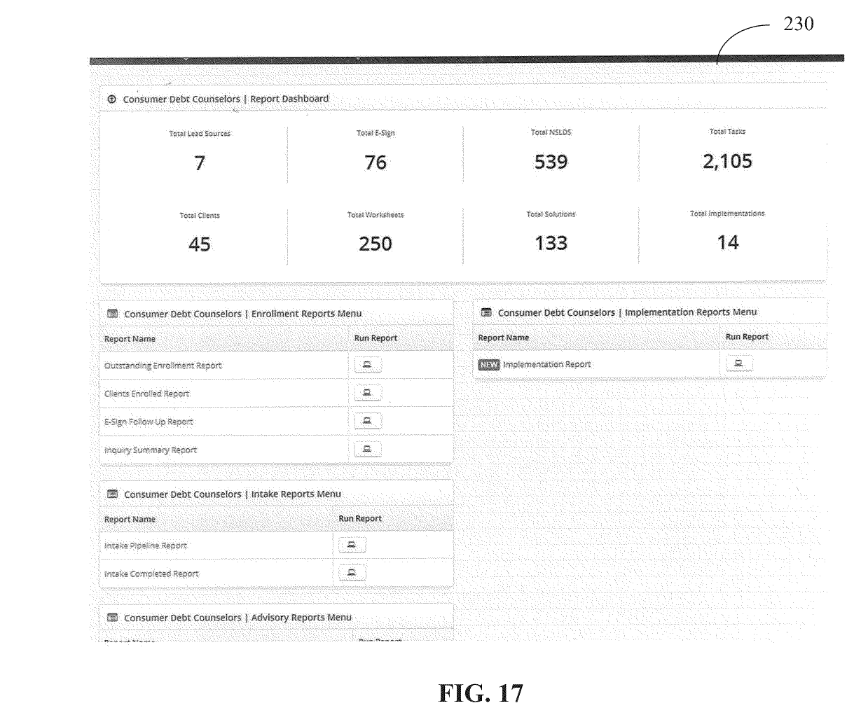

Referring now to FIG. 17, a screenshot 280 of a report dashboard is displayed and quantifies certain data. For example, this may include total lead sources, total e-signs, total NSLDS, total tasks, total clients, total worksheets, total solutions, total implementations. In addition, reports can be generated and printed from the GUI dashboard such as certain enrollment reports, intake reports, and advisory reports, for example.

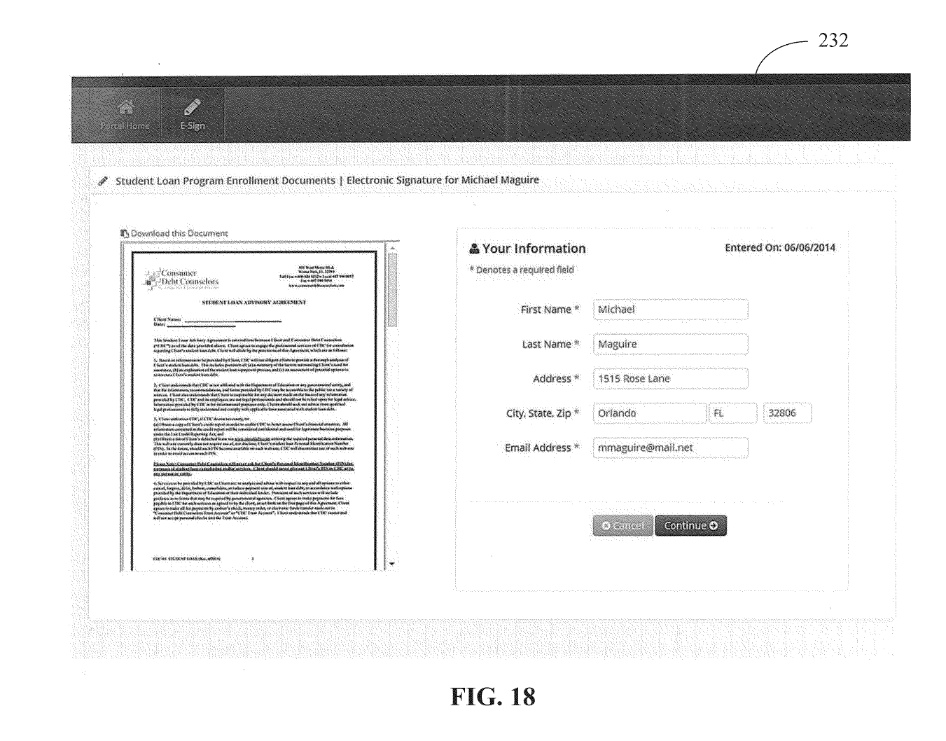

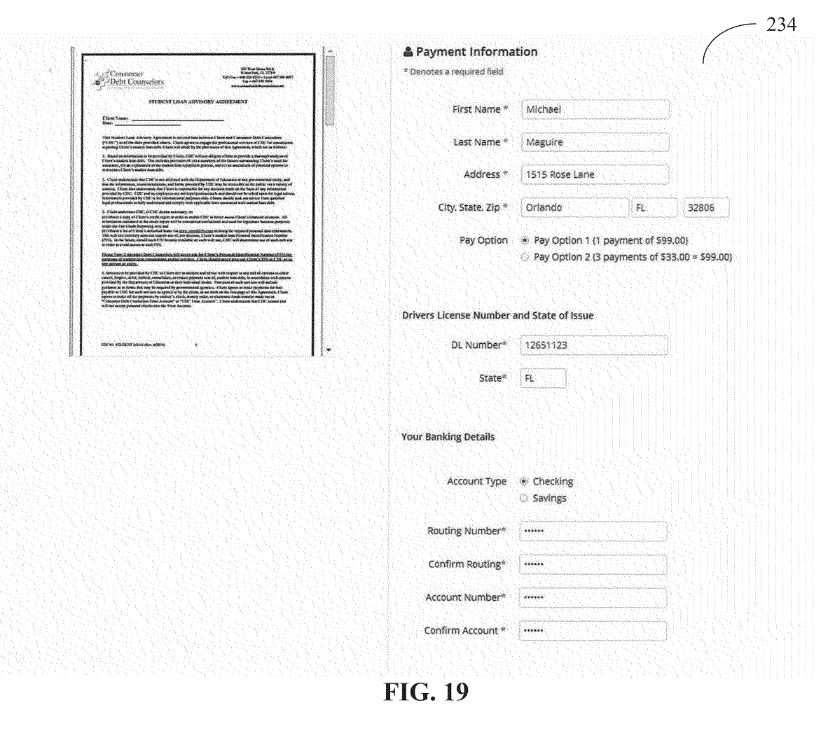

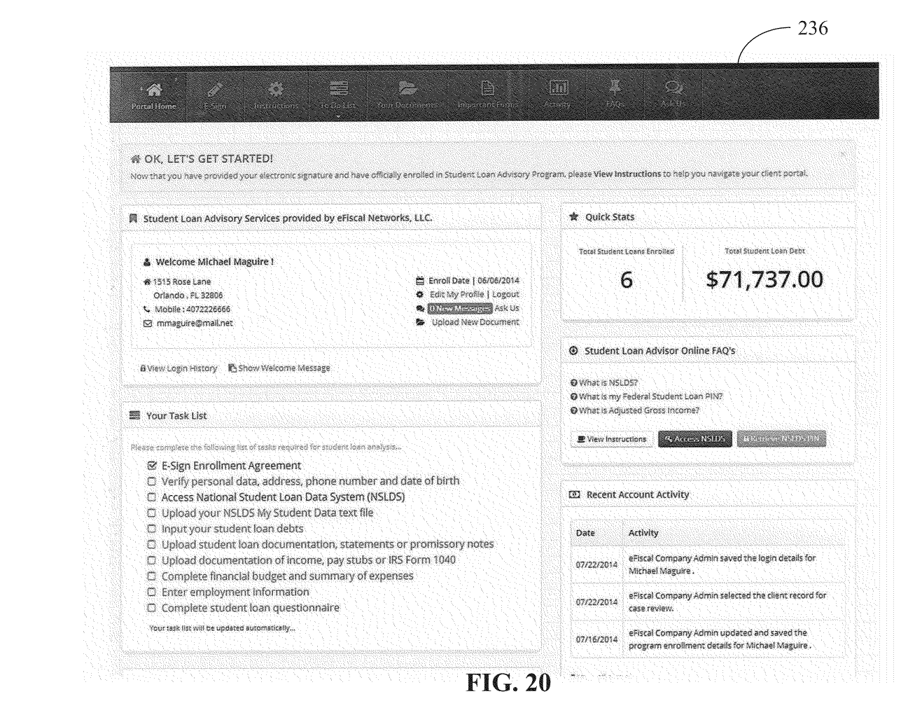

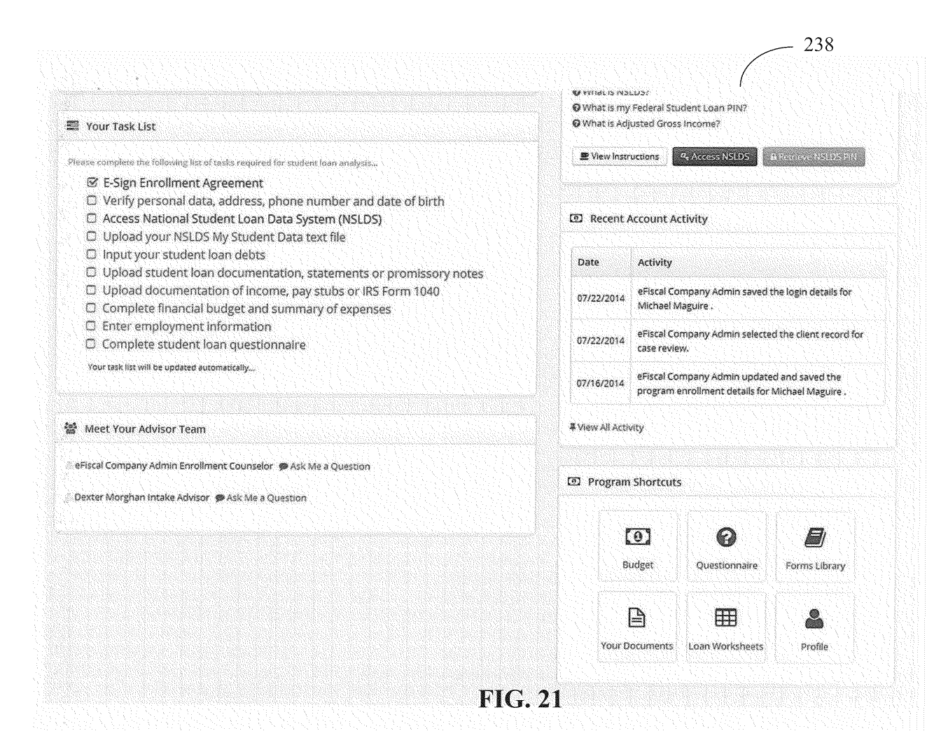

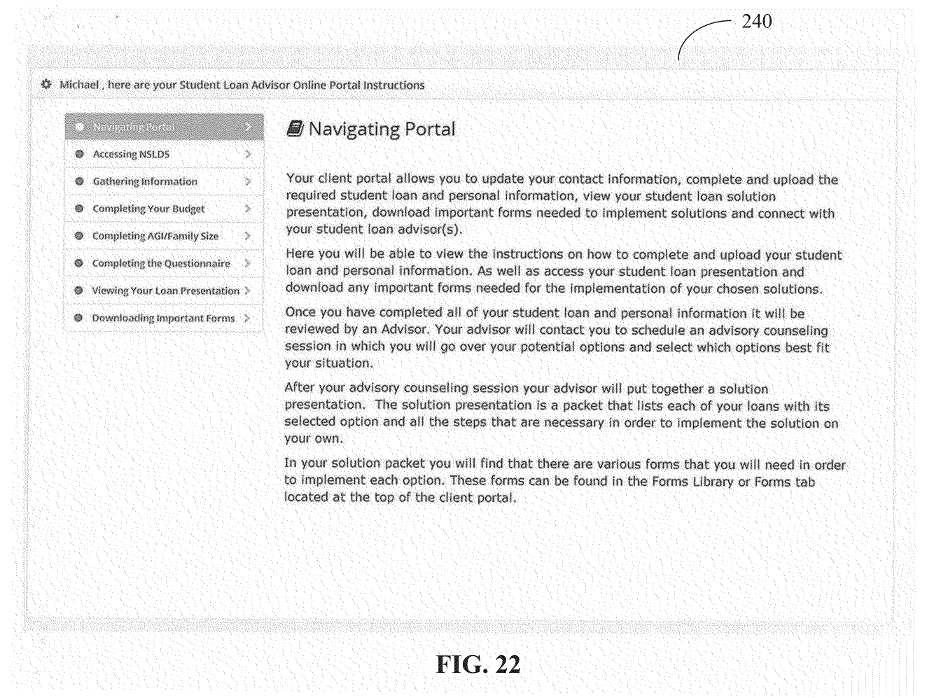

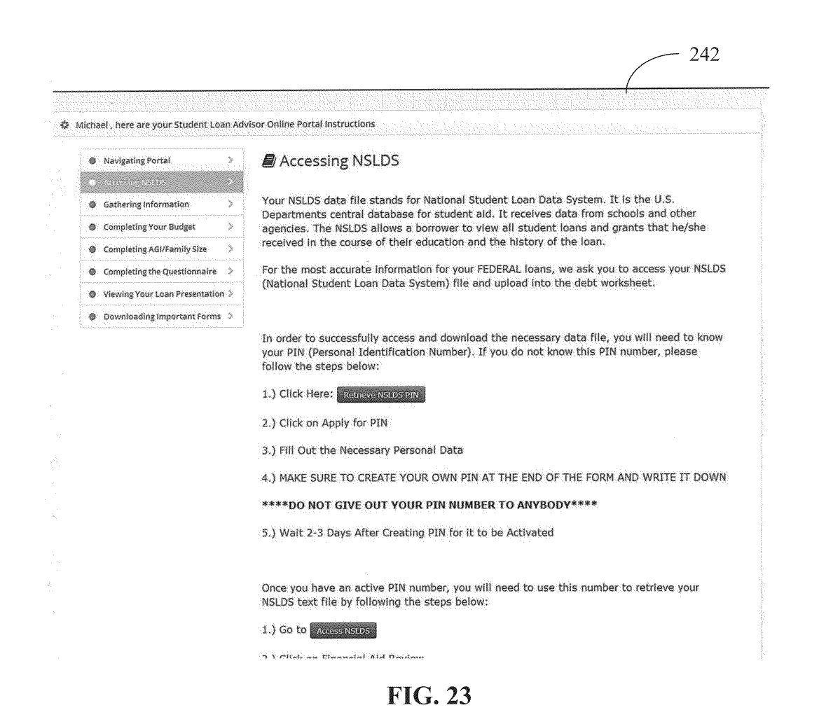

The enrollment process of a borrower in the method and system described above can be completed by the borrower using a portal similar to that shown in FIGS. 18-23. The borrower enters his or her name using the GUI as shown in screenshot 232. The borrower then selects a payment option as shown in screenshot 234. A student loan advisory agreement is also displayed for the borrower to review and execute. The borrower then proceeds to upload or otherwise input the student loan data using the portal. The student loan data is displayed as shown in screenshot 236. The portal includes displaying a task list, advisor information, and recent account activity, for example, as shown in screenshot 238. In addition, the portal may include access to a navigation portal as shown in FIG. 22 and screenshot 240. The portal also provides instructions to the borrower, as shown in FIG. 23 and screenshot 242, on how to view all student loans he or she received in the course of their education and the history of the loans.

A system can include a set of instructions that can be executed to cause a microprocessor of the system to perform any one or more of the methods or computer based functions disclosed herein. The system, or any portion thereof, may operate as a standalone device or may be connected, e.g., using a network, to other computer systems or peripheral devices. In a networked deployment, the system may operate in the capacity of a server, such as a video server or application server, or a media device. The system can also be implemented as or incorporated into various devices, such as a smart phone, personal computer (PC), a personal digital assistant (PDA), a mobile device, a palmtop computer, a laptop computer, a desktop computer, a communications device, a wireless telephone, a web appliance, a network router, switch or bridge, or any other machine capable of executing a set of instructions (sequential or otherwise) that specify actions to be taken by that machine. In a particular embodiment, the system can be implemented using electronic devices that provide voice, video or data communication. Further, the term “system” shall be taken to include any collection of systems or sub-systems that individually or jointly execute a set, or multiple sets, of instructions to perform one or more computer functions.

The system may include a microprocessor, e.g., a central processing unit (CPU), a graphics-processing unit (GPU), or both. Moreover, the system can include a main memory and a static memory that can communicate with each other via a bus. The system may further include a video display unit, such as a liquid crystal display (LCD), a flat panel display, a solid-state display, or a cathode ray tube (CRT). Additionally, the system may include one or more input devices, such as a keyboard, and a cursor control device, such as a mouse. The system can also include a disk drive unit, a signal generation device, such as a speaker or remote control, and a network interface device.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

What is claimed is:

1. A method for monitoring student loan debt relief programs, the method comprising:
receiving student loan data of a borrower over a network into a database comprising a microprocessor and a memory that stores the student loan data;
monitoring a plurality of universal resource locators (URL) over the network corresponding to a plurality of debt relief programs, respectively, to detect when a new set of rules is published on an URL for a respective debt relief program;
retrieving the new set of rules over the network from an URL of a respective debt relief program into the database that stores the new set of rules when the new set of rules is detected;
selecting particular data from the student loan data to compare to at least one new set of rules, wherein a different set of rules corresponds to each different student loan debt relief program;
formatting the student loan data with the at least one new set of rules into an option; and
transmitting the formatted option over the network to a remote computer device of the borrower.

2. The method of claim 1, further comprising:
generating a chart on the remote computer device using the formatted option to illustrate the respective student loan debt relief program within the plurality of different student loan debt relief programs;
visually identifying at least one available option of a plurality of options for the student loan debt relief program on the remote computer device; and
receiving a selected option by the borrower over the network from the remote computer device into the database.

3. The method of claim 2, further comprising:
generating at least one implementation report for display to identify steps necessary to receive student loan debt relief pursuant to the selected option; and
displaying a graphical user interface (“GUI”) on the remote computer device to apply for the selected option.

4. The method of claim 3, further comprising using the student loan data to format a sequence of forms of the new set of rules required to transmit to the respective URL for approval of the selected option for student loan debt relief.

5. The method of claim 4, further comprising displaying a visual indicator on the GUI as to a status of completion for implementation of the selected option for student loan debt relief.

6. The method of claim 5, further comprising:
determining whether the selected option for student loan debt relief is approved by a loan provider by receiving an alert over the network from the respective URL; and
implementing the selected option for student loan debt relief.

7. A method for monitoring student loan debt relief programs, the method comprising:
submitting student loan data into a remote database over a network using a graphical user interface (“GUI”) of a computer device of a borrower, the remote database comprising a microprocessor and a memory that stores the student loan data;
receiving a formatted option with the student loan data with at least one new set of rules using the computer device;
viewing a chart displayed by the GUI of a plurality of available options of student loan debt relief using the student loan data;
receiving additional formatted options from the remote database as a result of monitoring a plurality of universal resource locators (URL) over the network corresponding to a plurality of debt relief programs, respectively, to detect when a new set of rules is published on an URL for a respective debt relief program;
selecting at least one option for the student loan debt relief program using the GUI; and
receiving over the network from the remote database an implementation report having steps necessary displayed on the GUI to receive student loan debt relief pursuant to the selected at least one option.

8. The method of claim 7, further comprising:
receiving a sequence of forms over the network at the GUI that are required for approval of the selected option for student loan debt relief;
viewing a visual indicator on the GUI as to a status of completion for implementation of the selected option for student loan debt relief; and
receiving an approval from the remote database at the GUI when the selected option for student loan debt relief is approved.

9. A method for monitoring student loan debt relief programs, the method comprising:
monitoring a plurality of universal resource locators (URL) over a network corresponding to a plurality of debt relief programs, respectively, to detect when a new set of rules is published on an URL for a respective debt relief program, the database having a microprocessor and a memory that stores the student loan data; and
retrieving the new set of rules over the network from an URL of a respective debt relief program into the database that stores the new set of rules when the new set of rules is detected.

10. The method of claim 9, further comprising: receiving student loan data of a borrower over the network into the database.

11. The method of claim 10, further comprising selecting particular data from the student loan data to compare to at least one new set of rules, wherein a different set of rules corresponds to each different student loan debt relief program.

12. The method of claim 10, further comprising formatting the student loan data with the at least one new set of rules into an option.

13. The method of claim 12, further comprising transmitting the formatted option over the network to a remote computer device of the borrower.

14. The method of claim 13, further comprising generating a chart on the remote computer device using the formatted option to illustrate the respective student loan debt relief program within the plurality of different student loan debt relief programs.

15. The method of claim 13, further comprising visually identifying at least one available option of a plurality of options for the student loan debt relief program on the remote computer device.

16. The method of claim 13, further comprising receiving a selected option by the borrower over the network from a remote computer device into the database.

17. The method of claim 16, further comprising generating at least one implementation report on the remote computer device of the borrower for display to identify steps necessary to receive student loan debt relief pursuant to the selected option.

18. The method of claim 17, further comprising displaying a graphical user interface (“GUI”) on the remote computer device to apply for the selected option.

19. The method of claim 18, further comprising using the student loan data to format a sequence of electronic forms of the new set of rules required to transmit to the respective URL for approval of the selected option for student loan debt relief.

20. The method of claim 19, transmitting an alert to the remote computer device of the borrower when the selected option for student loan debt relief is approved by a loan provider.
